(19) United States
(12) Patent Application Publication
(10) Pub. No.: US 2018/0130075 A1
(43) Pub. Date: May 10, 2018

(54) ANALYSIS OF MEDIA CONSUMPTION FOR NEW MEDIA PRODUCTION

(71) Applicant: AMAZON TECHNOLOGIES, INC., Seattle, WA (US)

(72) Inventor: Sonali Roy, Santa Monica, CA (US)

(21) Appl. No.: 14/658,868

(22) Filed: Mar. 16, 2015

(51) Int. Cl. G06Q 30/02; H04L 29/06

(52) U.S. Cl. CPC G06Q 30/0203; H04L 67/42; H04L 65/4069

(57) ABSTRACT

Disclosed are various embodiments for analyzing media performance as a basis for production of new media. A computing device identifies a plurality of attributes correlated with performance of a media file. The computing device then selects a plurality of media files for testing, wherein individual ones of the plurality of media files have at least one of the plurality of attributes. The computing device sends at least one of the plurality of media files to a client device. Subsequently, the computing device calculates a rating for the at least one of the plurality of media files based at least in part on a response on feedback data received from the client device.

### BACKGROUND

Production of media content may be expensive. To decrease costs, a media content producer may create preview or teaser media to test market reception of a concept before committing to produce full-length content. For example, a media producer may produce an animated storyboard first to test a concept of a movie or television show, then create a trailer to further gauge reactions to a movie or television concept. If the reception to the animated storyboard or trailer is positive, the media content producer may then commission a full-length feature movie or full season of a television show.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered according to various embodiments of the present disclosure.

FIG. 2 is a drawing of a networked environment according to various embodiments of the present disclosure.

FIG. 3 is a flowchart illustrating one example of functionality implemented as portions of an application executed in a computing environment in the networked environment of FIG. 2 according to various embodiments of the present disclosure.

FIG. 4 is a flowchart illustrating one example of functionality implemented as portions of an application executed in a computing environment in the networked environment of FIG. 2 according to various embodiments of the present disclosure.

FIG. 5 is a flowchart illustrating one example of functionality implemented as portions of an application executed in a computing environment in the networked environment of FIG. 2 according to various embodiments of the present disclosure.

FIG. 6 is a schematic block diagram that provides one example illustration of a computing environment employed in the networked environment of FIG. 2 according to various embodiments of the present disclosure.

### DETAILED DESCRIPTION

Disclosed are various embodiments for identifying factors of consumed media items to optimize producing new media titles. First, a statistical analysis of media files is performed to identify attributes most correlated with consumption of a media file. Once the key attributes are identified, which may vary by genre or other factors, a full matrix of possible attribute combinations may be created. Each combination of attributes may form a profile for a media file that may be subsequently presented to a user. Each media file may then be presented to one or more users, and feedback may be used to identify an optimal attribute or combination of attributes that would predict the success of a new media tile produced based upon the viewed media files. In the following discussion, a general description of the system and its components is provided, followed by a discussion of the operation of the same.

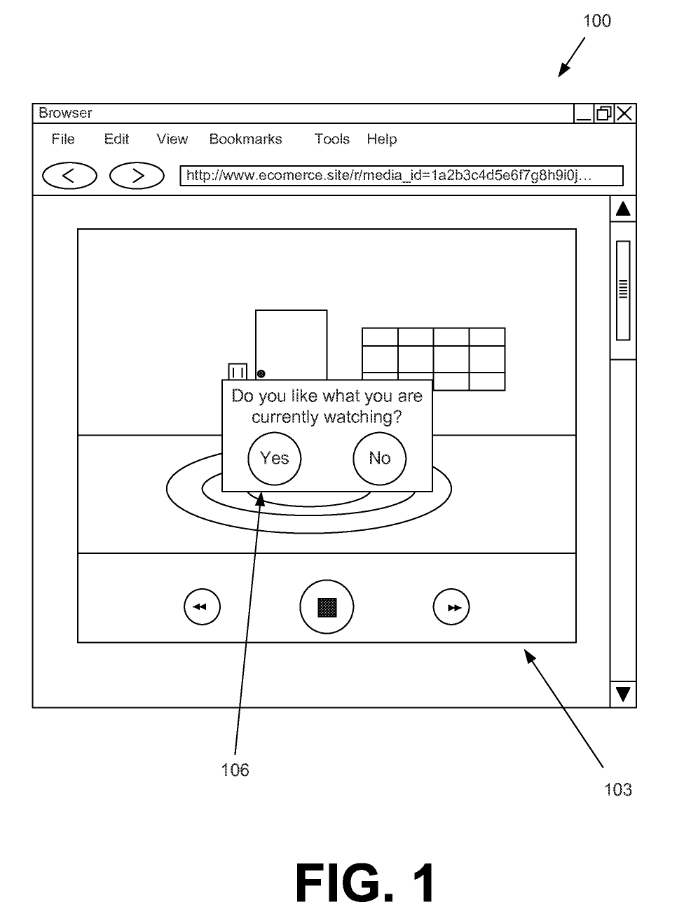

With reference to FIG. 1, shown is a user interface 100 according to various embodiments of the present disclosure. The user interface 100 may correspond to an interface for a browser, a media rendering application, or similar application. The user interface 100 may include a number of user interface elements, such as a media player 106 and/or other user interface elements. The media player 106 may be used to consume various types of digital media, such as digital audio and/or digital video.

In various embodiments, a prompt 106 may be rendered in addition to the other user interface elements. The prompt 106 may be used to obtain input from a user regarding the digital media they are currently consuming with the media player 106. The prompt 106 may, for example, ask how a user enjoyed the digital media that the user consumed or ask how a user enjoyed the last segment or portion of the digital media that the user consumed. In some embodiments, the prompt 106 may be surfaced upon completion of consumption of the digital media or may be surfaced periodically during consumption of the digital media, as will be described in further detail herein. As described in further detail herein, the feedback that the user provides via the prompt 106 is then used to determine whether additional media content should be produced.

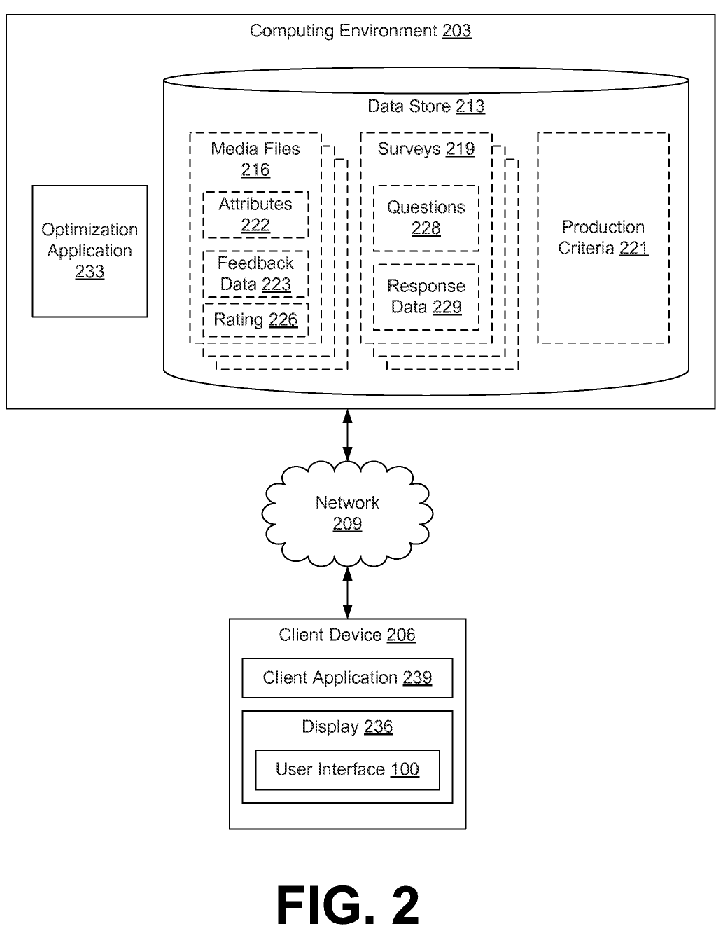

With reference to FIG. 2, shown is a networked environment 200 according to various embodiments. The networked environment 200 includes a computing environment 203 and a client device 206, which are in data communication with each other via a network 209. The network 209 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 213 that is accessible to the computing environment 203. The data store 213 may be representative of a plurality of data stores 213 as can be appreciated. The data stored in the data store 213, for example, is associated with the operation of the various applications and/or functional entities described below. The data stored in the data store 213 includes, for example, media files 216, surveys 219, production criteria 221, and potentially other data.

Media files 216 represent audio and/or video content in a digital format, such as various Moving Picture Experts Group (MPEG) formats (e.g. MPEG-1, MPEG-2, MPEG-4, H.264, H.265, and similar formats), various open source formats (e.g. Theora, VP6, VP8, and similar formats), and/or other formats. A media file 216 may represent, for example, songs, broadcasts, television episodes, movies, trailers, animated video (including television, movies, and trailers), and various other works.

The attributes 222 of a media file 216 represent one or more attributes that are generally correlated with consumption of media files 216. Examples of attributes 222 include a genre of the media file 216 (e.g. music genre, movie genre, etc.), a length of the media file 216, an artist associated with the media file 216 (e.g. an actor in a film or a singer or musician in a band), as well as other attributes. Some attributes 222 may correlate highly with consumption of a media file 216, indicating that media files 216 with a particular attribute 222 are more likely to be consumed than media files 216 without the particular attribute 222. For example, media files 216 with an attribute 222 indicating a short length may be consumed more frequently than media files 222 indicating a longer length. In some instances, a single attribute 222 may not correlate highly with consumption of a media file 216, but particular combinations of attributes 222 may correlate highly with consumption of a media file 216 when all attributes 222 in the combination of attributes 222 are present. For example, romantic comedies may be watched with a similar frequency as action movies, but a romantic comedy starring a particular actor may be watched more frequently than romantic comedies or action movies generally.

The feedback data 223 of a media file 216 represents user feedback from one or more users regarding the media file. Feedback data 223 may represent a user's rating of a media file 216, a user's rating of a segment or portion of a media file 216, a series of ratings of a series of segments or portions of the media file 216, or some combination thereof. Ratings included in feedback data 223 may be represented in a numeric manner (e.g. a scale of 1-5, a scale of 1-10, or similar scale), in a binary manner (e.g. pass/fail, approved/unapproved, liked/disliked, popular/unpopular, or similar binary values), or in some other manner. In those embodiments that represent ratings in a numeric manner, individual numbers on the scale may be mapped to non-numeric representations. For example, a scale of 1-5 may be represented as 1-5 stars, or may be represented with phrases such as “strongly dislike,” “somewhat dislike,” “neutral,” “like,” and “strongly like,” which may map to numbers 1, 2, 3, 4, and 5, respectively.

A media file's 216 rating 226 represents a rating for the medial file 216 based upon the feedback data 223 received from one or more users, as will be described in further detail herein. As one example, a rating 216 for a media file 216 may be generated by averaging ratings in the feedback data 223 provided by users, by using a median rating in the feedback data 223 provided by users as the rating 226, or by performing some other statistical operation on or analysis of the feedback data 223.

Surveys 219 represent one or more questions 228 sent to a user after he or she has consumed a media file 216 and the response data 229 representing responses to the questions 228. The questions 228 included in the survey may be used to elicit more detailed or nuanced feedback than can be gleaned from feedback data 223 provided by individual users. Questions 228 may include whether a new media file 216 should be created based on the consumed media file 216, such as whether an album should be created based on a song that was listened to, whether a movie or television series should be created based on a trailer that was viewed, or similar questions. Questions 228 may also include whether a new media file 216 based on the consumed media file 216 will be commercially successful. For example, a question 228 may ask for a prediction of box office revenues for a movie based on a trailer that was watched, or a question 228 may ask for a prediction of a number of albums sold based on a song listened to by the user.

Production criteria 221 represent one or more thresholds, factors, and/or other considerations which must be present or satisfied in order for the optimization application 233 to determine that a second media file 216 should be generated based on a first media file 216. For example, a media file 216 may represent a movie trailer and the production criteria 221 may represent a minimum rating 226 required for the media file 216 in order for the optimization application 233 to determine that a movie should be made that is based on the movie trailer depicted by the media file 216. As another example, a media file 216 may represent an animated storyboard and the production criteria 221 may include a minimum rating 226 required for the media file in order for the optimization application 233 to determine that a movie trailer should be made based on the animated storyboard. In various embodiments, such as those where multiple media files 216 corresponding to animated storyboards representing different possible movie trailers for the same movie are available to consumers, the production criteria 221 may include a minimum rating 226 for a segment of one of the animated storyboards to be included in a trailer.

The components executed on the computing environment 203, for example, include the optimization application 216, and other applications, services, processes, systems, engines, or functionality not discussed in detail herein. The optimization application 233 is executed to generate ratings 229 based on feedback data 223 and to determine whether a new media file 216 should be generated based at least in part on ratings 226 for one or more media files 216 and/or response data 229 for one or more surveys 219 sent to one or more consumers of the media files 216.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 206 may include a display 236. The display 236 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 239 and/or other applications. The client application 239 may be executed in a client device 206, for example, to access network content served up by the computing environment 203 and/or other servers, thereby rendering a user interface 100 on the display 236. To this end, the client application 239 may comprise, for example, a browser, a dedicated application, etc., and the user interface 100 may comprise a network page, an application screen, etc. The client device 206 may be configured to execute applications beyond the client application 239 such as, for example, email applications, social networking applications, word processors, spreadsheets, and/or other applications.

Next, a general description of the operation of the various components of the networked environment 200 is provided. To begin, a user of the client device 206 uses the client application 239 to consume a media file 216. For example, the user may use the client application 239 to view an animated storyboard of a potential movie or a movie trailer for a potential movie.

The optimization application 233 may periodically send a feedback request to the client application 239 while the user views the media file 216. For example, the optimization application 233 may send a feedback request every 5, 10, 15, 20, or 30 seconds, or at other intervals. In various embodiments, the optimization application 233 may send a feedback request at specific points, such as at the end of a scene of a trailer or after a user has moved on to the next frame in an animated storyboard.

In response to each feedback request received, the client application 239 may cause a user interface element to be rendered within the user interface 100 of the client application 239 on the display 236 of the client device 206. This may prompt the user to indicate whether they like or dislike the media file 216, liked or disliked the previous segment or portion of the media file 216, to provide a rating for the media file 216 or the previous segment or portion of the media file 216 based on a scale presented to the user, or a similar prompt. The client application 239 sends the user's feedback to the optimization application 233, which may be stored as feedback data 223 for the media file 216 currently being consumed.

The optimization application 233 may then analyze the feedback data 223 to generate a rating 226, as will be described in further detail herein. To generate a rating 226 for the media file 216, the optimization application 233 may analyze feedback data 223 received from multiple consumers of the media file 216.

Upon completion of consumption of the media file 216, the optimization application 233 may send a survey 219 to the client application 239 for presentation to the user. The survey 219 may include a number of questions 228 about the media file that was previously consumed. After collecting the user's answers to the questions 228 contained in the survey 219, the client application 239 sends the user's answers back to the optimization application 233 for storage as response data 229.

The optimization application 233 may then analyze the feedback data 223 for and rating 226 of the media file 216 and, in some embodiments, the feedback data 223 and rating 226 of related media files 216, as well as the response data 229 of the corresponding surveys 219, to determine whether a new media file 216 should be generated and/or produced. For example, the optimization application 233 may determine whether one or more production criteria 221 for producing a new media file 216, such as a movie based on or represented by an existing trailer or a trailer based on or represented by an existing animated storyboard, should be produced.

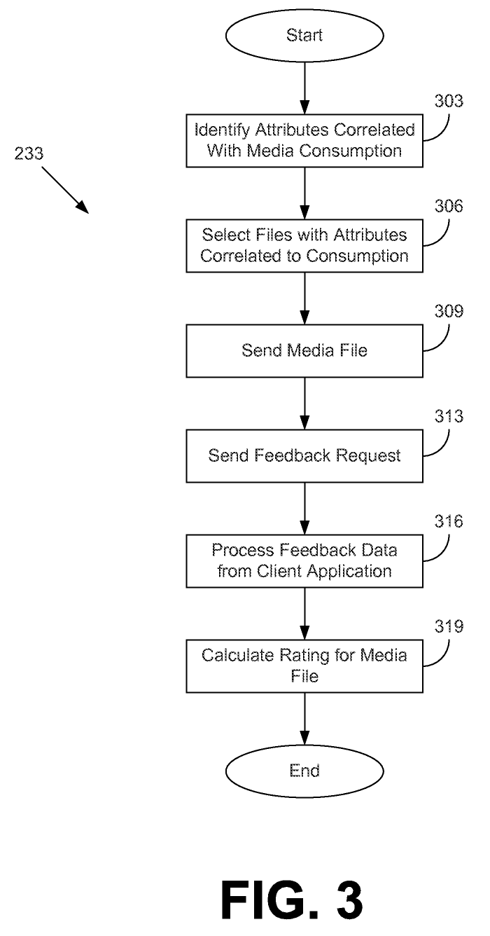

Referring next to FIG. 3, shown is a flowchart that provides one example of the operation of a portion of the optimization application 233 according to various embodiments. It is understood that the flowchart of FIG. 3 provides merely an example of the many different types of functional arrangements that may be employed to implement the operation of the portion of the optimization application 233 as described herein. As an alternative, the flowchart of FIG. 3 may be viewed as depicting an example of elements of a method implemented in the computing environment 203 (FIG. 2) according to one or more embodiments.

Beginning with box 303, the optimization application 233 identifies one or more attributes 222 (FIG. 2) correlated with consumption of one or more media files 216 (FIG. 2). The optimization application 233 may, for example, identify a number of times that a media file 216 with a particular attribute 222 has been viewed and then perform a statistical analysis, such as a regression analysis or other statistical analysis or machine learning approach, to determine whether a correlation exists. Where multiple attribute 222 analysis is desired, the optimization application 233 may build a full matrix of all possible combinations of attributes 222, allowing the optimization application 233 to identify both individual attributes 222 and combinations of attributes 222 that are correlated with media consumption.

Moving on to box 306, the optimization application 233 selects one or more media files 216 that have one or more of the identified attributes 222. By selecting only those media files 216 that have at least one attributes 222 correlated with media consumption, the optimization application 233 is able to reduce the number of media files 216 that will be subjected to further analysis.

Referring next to box 309, the optimization application 233 sends a media file 216 to the client application 239 (FIG. 2) in response to a request from the client application 239. In some embodiments, the media file 216 sent is the media file 216 that was selected by the client application 239. However, the optimization application 233 may select a media file 216 at random from a plurality of media files 216, as previously identified in boxes 303 and 306, to send to the client application 239 in response to a request from the client application 239 for a media file 216. For example, where multiple storyboards or multiple trailers exist for a particular movie or television show concept, the optimization application 233 may send a random media file 216 corresponding to a random one of the multiple storyboards or multiple trailers. The optimization application 233 may do this in order to ensure that a statistically significant amount of feedback data 223 for each media file 216 is eventually compiled.

Proceeding next to box 313, the optimization application 233 sends a feedback request to the client application 239. The feedback request may be sent upon completion of consumption of the media file 216, periodically at predefined intervals of time during consumption of the media file 216, at the predefined points during consumption of the media file, and/or at other times. The feedback request may also specify the type of feedback to be solicited from a user, such as a rating on a numeric scale, a binary scale, and/or some other type of rating, as previously described. The feedback request causes the client application 239 to prompt the user for feedback regarding the media file 216 currently playing.

Moving on to box 316, the optimization application 233 processes the feedback data 223 received from the client application 239 in response to the previously sent feedback request. The optimization application 233 may, for example, verify the integrity of the feedback data 223, and/or store the feedback data 223 in the data store 213 (FIG. 2) in association with the media file 216. For example, the optimization application 233 may verify that the user of the client application 239 actually provided feedback instead of ignoring prompts for feedback data 223 generated by the client application 239.

Referring next to box 319, the optimization application 233 may calculate a rating 226 (FIG. 2) for the media file 216 by combining or aggregating the feedback data 223 received from the client application 239 and/or previously received feedback data 223 received from other users of the client application 239. For example, in embodiments where the feedback data 223 corresponds to a numeric rating on a numeric scale, the optimization application 233 may average the received feedback data 223 with previously received feedback data 223 to generate a rating 226 that reflects an average score. In embodiments where feedback data 223 is received for individual segments or portions of the media file 216, such as scenes of a movie trailer, the optimization application 233 may make a similar calculation to generate a rating 226 for each segment or portion of the media file 216 in addition to an overall rating 226 for the media file 216. The previously described path of execution of the optimization application 233 subsequently ends.

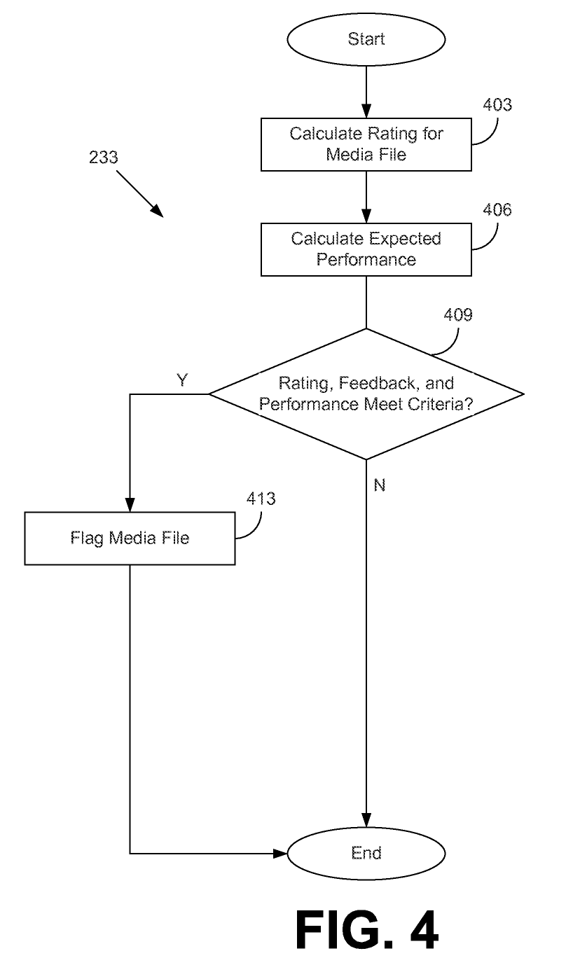

Referring next to FIG. 4, shown is a flowchart that provides one example of the operation of a portion of the optimization application 233 according to various embodiments. It is understood that the flowchart of FIG. 4 provides merely an example of the many different types of functional arrangements that may be employed to implement the operation of the portion of the optimization application 233 as described herein. As an alternative, the flowchart of FIG. 4 may be viewed as depicting an example of elements of a method implemented in the computing environment 203 (FIG. 2) according to one or more embodiments.

Beginning with box 403, the optimization application 233 calculates a rating 226 (FIG. 2) for a media file 216 (FIG. 2) by combining or aggregating the feedback data 223 (FIG. 2) that has been received with previously received feedback data 223. For example, in embodiments where the feedback data 223 corresponds to a numeric rating on a numeric scale, the optimization application 233 may average the received feedback data 223 with previously received feedback data 223 to generate a rating 226 that reflects an average score. In embodiments where feedback data 223 is received for individual segments or portions of the media file 216, such as scenes of a movie trailer, the optimization application 233 may make a similar calculation to generate a rating 226 for each segment or portion of the media file 216 in addition to an overall rating 226 for the media file 216.

Proceeding next to box 406, the optimization application 233 calculates an expected performance (e.g. as an expected revenue, an expected number of views, an expected number of number of downloads, and/or similar metric) for a derivative work based at least in part on one or more of response data 229 (FIG. 2) for surveys 219 (FIG. 2) sent out to consumers of the media file 216, the rating 226 of the media file 216, and/or feedback data 223 received from one or more users. For example, a question 228 (FIG. 2) of a survey for viewers of a movie trailer may be asked to estimate box office receipts for a movie based on the viewed movie trailer. Although any individual response may be not be accurate, a statistical analysis, such as a regression analysis or various other statistical analyses or machine learning approaches, may be performed on the response data 229 may show that the individual responses to the question are converging on a particular value, which may be used in some embodiments as the estimated expected revenue for a movie based on the movie trailer.

Referring next to box 409, the optimization application 233 determines whether the estimated expected performance of a derivative work based on the media file 216 will meet one or more predefined production criteria 221. The determination may be based at least in part on one or more of the rating 226 of the media file 216, the feedback data 223 received from one or more users, and/or the expected performance calculated previously at box 406. For example, the optimization application 233 may determine whether the estimated expected revenue meets or exceeds the projected costs of creating a derivative work. As another example, the optimization application 233 may determine whether the rating 226 of the media file meets or exceeds a threshold rating 226, which may indicate how well received a derivative work would be. In various embodiments, the optimization application 233 may determine whether the expected number of views (e.g. views or downloads view a streaming media service or similar delivery system) will meet or exceed a predefined threshold number of views. If either the rating 226 or the estimated expected revenue, or in some embodiments both the rating 226 and the estimated expected revenue, meet the appropriate production criteria 221, then execution proceeds to box 413. However, if neither the rating 226 nor the estimated expected revenue meet the specified production criteria, then the previously described path of execution subsequently ends.

Moving on box 413, the optimization application 233 flags the media file 216 for use as a basis for a derivative work. For example, if the media file 216 is an animated storyboard, then the optimization application 233 may flag the media file 216 for use as the basis of a movie trailer. If the media file 216 is a movie trailer, then the optimization application 233 may flag the media file 216 for use as the basis of a movie. Then the previously described path of execution subsequently ends.

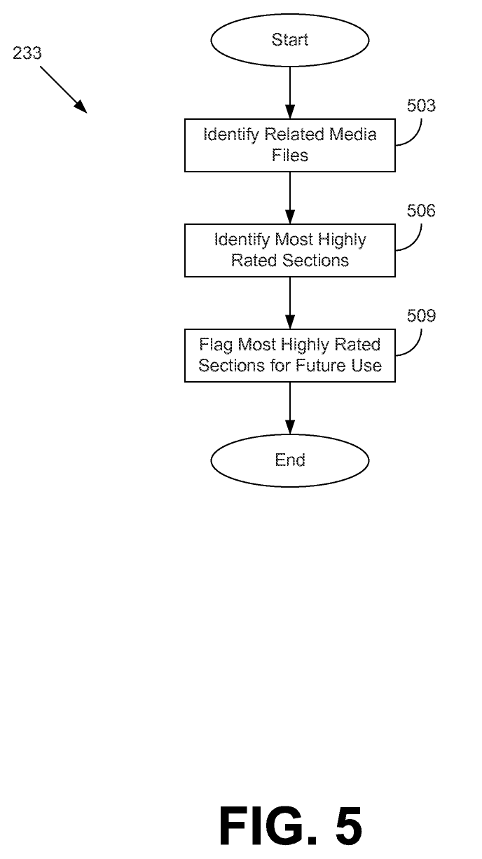

Referring next to FIG. 5, shown is a flowchart that provides one example of the operation of a portion of the optimization application 233 according to various embodiments. It is understood that the flowchart of FIG. 5 provides merely an example of the many different types of functional arrangements that may be employed to implement the operation of the portion of the optimization application 233 as described herein. As an alternative, the flowchart of FIG. 5 may be viewed as depicting an example of elements of a method implemented in the computing environment 203 (FIG. 2) according to one or more embodiments.

Beginning with box 503, the optimization application 233 identifies one or more related media files 216 (FIG. 2). For example, the related media files 216 may be media files 216 from the same genre (e.g. same movie genre, television genre, music genre). In some instances, the related media files 216 may be different versions of the same media file 216, such as different versions of a movie trailer or different versions of a storyboard for a script.

Proceeding next to box 506, the optimization application 233 identifies the most highly rated sections of each of the related media files 216. In those embodiments where the media files 216 correspond to a movie trailer, the optimization application 233 may, for example, identify which media file 216 has the most highly rated opening scene, ending, or other section. The optimization application 233 may accomplish this, for example, by comparing the rating 226 (FIG. 2) of the individual sections of the individual media files 216.

Referring next to box 509, the optimization application 233 flags the most highly rated one of each of the sections for future use. For example, the optimization application 233 may flag the most highly rated opening scene from the related media files 216, the most highly rated ending from among the related media files 216, as well as take similar actions of other defined or identifiable sections of each of the media files 216. For example, the flagged sections may be used to generate an optimized media file 216, such as a movie trailer, that contains the most highly ranked sections of each of the related media files 216. The previously described path of execution subsequently ends.

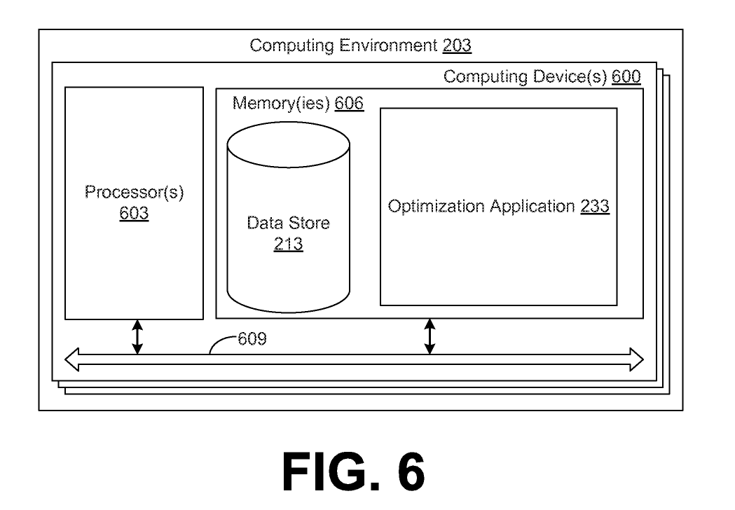

With reference to FIG. 6, shown is a schematic block diagram of the computing environment 203 according to an embodiment of the present disclosure. The computing environment 203 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are an optimization application 233, and potentially other applications. Also stored in the memory 606 may be a data store 213 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the optimization application 233, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the optimization application 233. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. Further, in some embodiments, one or more of the blocks shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the optimization application 233, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the optimization application 233, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium comprising machine-readable instructions that, when executed by a processor of at least one computing device, cause the at least one computing device to at least:
stream a first media file to a client device;
periodically send a plurality of feedback requests to the client device during streaming of the first media file;
calculate a rating for the first media file based at least in part on a plurality of responses to respective ones of the plurality of feedback requests received from the client device, each of the plurality of responses corresponding to at least one of the plurality of feedback requests;
identify at least one of the plurality of responses that corresponds to a predefined segment of the first media file;
calculate a first segment rating for the predefined segment of the first media file based at least in part on the at least one of the plurality of responses;
compare the first segment rating to a second segment rating for a corresponding segment of a second media file; and
determine whether the predefined segment of the first media file is more highly rated than the corresponding segment of the second media file based at least in part on the comparison of the first segment rating to the second segment rating.

2. (canceled)

3. The non-transitory computer-readable medium of claim 1, wherein the machine readable instructions further cause the computing device to at least calculate the rating for the first media file further causes the computing device to average feedback data included in at least one of the plurality of responses to the plurality of feedback requests with other feedback data included in another response received from at least one other client device.

4. A method, comprising:
identifying, via a computing device, a plurality of attributes correlated with performance of a media file;
selecting, via the computing device, a plurality of media files for testing, wherein individual ones of the plurality of media files have at least one of the plurality of attributes;
sending, via the computing device, at least one of the plurality of media files to a client device;
periodically sending, via the computing device, a request to the client device for feedback data; and
calculating, via the computing device, a rating for the at least one of the plurality of media files based at least in part on feedback data received from the client device.

5. The method of claim 4, further comprising selecting at random, via the computing device, the at least one of the plurality of media files to send the client device from the plurality of media files.

6. The method of claim 4, further comprising:
determining, via the computing device, that a first one of the plurality of media files is more highly rated than a second one of the plurality of media files; and
identifying, via the computing device, an attribute associated with the first one of the plurality of media files that is not associated with the second one of the plurality of media files.

7. The method of claim 4, further comprising:
sending, via the computing device, a survey to the client device, wherein the survey comprises a series of questions regarding the media file; and
calculating, via the computing device, an anticipated performance for a media title derived from the media file, wherein the anticipated performance is based at least in part on a response to the survey.

8. The method of claim 4, wherein the plurality of attributes comprise a genre associated with the media file, a length of the media file, and an artist associated with the media file.

9. The method of claim 4, wherein calculating the rating for the at least one of the plurality of media files further comprises combining, via the computing device, the feedback data received from the client device with other feedback data for the at least one of the plurality of media files.

10. The method of claim 4, wherein identifying the plurality of attributes correlated with performance of a media file further comprises:
building, via the computing device, a matrix comprising every combination of the plurality of attributes; and
identifying, via the computing device, individual combinations of the plurality of attributes that correlate with performance of the media file.

11. The method of claim 10, wherein identifying the individual combinations of the plurality of attributes that correlate with performance of the media file is based at least in part on a statistical analysis of the matrix comprising every combination of the plurality of attributes.

12. A system, comprising:
at least one computing device comprising a processor and a memory; and
machine readable instructions stored in the memory that, when executed by the processor, cause the computing device to at least:
stream a first media file to a client device;
send a plurality of feedback requests to the client device during streaming of the media file, individual ones of the plurality of feedback requests being sent at a periodic interval;
receive a plurality of responses from the client device, individual ones of the plurality of responses corresponding to respective ones of the plurality of feedback requests sent at the period interval;
identify at least one of the plurality of response that corresponds to a predefined segment of the first media file;
calculate a first segment rating for the predefined segment of the first media file based at least in part on the at least one of the plurality of responses;
compare the first segment rating to a second segment rating for a corresponding segment of a second media file;
determine that the predefined segment of the first media file is more highly rated than the corresponding segment of the second media file based at least in part on the comparison of the first segment rating to the second segment rating; and
calculate a rating for the media file based at least in part on the plurality of responses to the plurality of feedback requests received from the client.

13. The system of claim 12, wherein the first media file is selected at random from a plurality of related media files.

14. The system of claim 12, wherein at least one of the plurality of feedback requests comprises a request for a rating of the first media file.

15. The system of claim 12, wherein at least one of the plurality of feedback requests comprises:
an identification of a segment of the first media file; and
a request for a rating of the segment of the first media file.

16. The system of claim 12, wherein the machine readable instructions that cause the computing device to calculate the rating for the first media file further causes the computing device to aggregate feedback data included in the response to the feedback request received from the client device with other feedback data included in another response received from at least one other client device.

17. (canceled)

18. The system of claim 12, wherein the machine readable instructions further cause the computing device to include the predefined segment of the first media file in a list of potential segments for a derivative work based at least in part on the first media file and the second media file.

19. The system of claim 12, wherein the machine readable instructions further cause the computing device to at least:
send a survey to the client device;
analyze a completed survey from the client device; and
determine, based at least in part on the completed survey, that a new media file is to be generated.

20. The system of claim 19, wherein the completed survey comprises a revenue estimation of the new media file and the machine readable instructions further cause the computing device to at least calculate an expected performance for the second media file.

21. The system of claim 12, wherein the first media file is selected at random to stream to the client device from a plurality of media files and the machine readable instructions are further configured to select the first media file at random from the plurality of media files.

22. The system of claim 12, wherein the machine readable instructions that cause the computing device to calculate the rating further cause the computing device to calculate the rating further based at least in part on feedback data received from another client device.
